(19) United States
(12) Patent Application Publication
(10) Pub. No.: US 2026/0185421 A1
(43) Pub. Date: Jul. 2, 2026

(54) METHOD FOR MAXIMIZING WATER INJECTION AND ENSURING THE INTEGRITY OF AN OIL RESERVOIR, AND COMPUTER-READABLE STORAGE MEDIUM

(71) Applicants: Petróleo Brasileiro S.A. – Petrobras, Rio de Janeiro (BR); Universidade Federal do Rio Grande do Sul – UFRGS, Porto Alegre (BR)

(72) Inventors: Fabio Cesar DIEHL, Rio de Janeiro (BR); Tatiane Oliveira MACHADO, Rio de Janeiro (BR); Jorge Otávio TRIERWEILER, Porto Alegre (BR); Marcelo FARENZENA, Porto Alegre (BR)

(21) Appl. No.: 19/429,153

(22) Filed: Dec. 22, 2025

(30) Foreign Application Priority Data
Dec. 30, 2024 (BR) 1020240275284

(51) Int. Cl. E21B 34/16; E21B 43/20; G05B 13/02; G05D 7/06

(52) U.S. Cl. CPC E21B 34/16; E21B 43/20; G05B 13/027; G05D 7/0623; G05D 7/0635; E21B 2200/22

(57) ABSTRACT

The present disclosure relates to a method for maximizing water injection and ensuring the integrity of an oil reservoir, comprising the steps of receiving (S100) well information, estimating (S200) the boundary value of the geomechanical pressure, defining (S300) the reference values for the water injection portion, defining (S400) the reference values for bottomhole pressure, controlling (S500) the water injection flow rate, monitoring (S600) the reservoir state, and controlling (S700) the opening value of the control valve.

### CROSS-REFERENCE

This application claims priority to Brazilian patent application Ser. No. 10/202,40275284, filed Dec. 30, 2024, which is incorporated herein in its entirety by reference thereto.

### TECHNICAL FIELD

The present disclosure pertains to the field of offshore oil exploration and production (E&P) and technology for supporting and automating operational decisions in water injection wells. In this way, the present disclosure focuses on the description of a method and system for decision support based on models and algorithms that enable the optimization of the efficiency of injection wells in oil and gas reservoirs and the assurance of the integrity of these reservoirs.

### BACKGROUND

The Stationary Production Units (SPUs) are offshore platforms responsible for extracting and separating petroleum into three components: oil, water, and gas. The oil can be stored, exported via oil pipelines, or transferred to other vessels. Water taken from the sea or produced by oil wells undergoes treatment and can be injected/reinjected, used in other applications, or disposed of under regulatory requirements. Gas is compressed in the SPU processing plant and can be exported, used in oil recovery, or flared for power generation. Some of the water and gas return to the reservoir after passing through equipment in the SPU processing plants.

Water injection in oil reservoirs is a widely used technique in the oil industry and plays a crucial role in several steps of oil production. This practice offers several benefits that help maximize oil recovery and extend the lifespan of oil fields.

Water injection in oil reservoirs is a technique that helps maintain or increase the internal pressure of the reservoir, ensuring more efficient extraction and extending the lifespan of the fields. By acting as a “pusher,” water displaces oil from hard-to-reach areas, increasing the amount of recoverable oil, especially in low-permeability reservoirs. In addition, the technique allows control of the water-to-oil ratio produced, optimizing production and reducing costs associated with water treatment and disposal. It is also used in secondary and tertiary recovery, combining with other methods to maximize extraction in mature fields. From an environmental standpoint, produced water reinjection minimizes the environmental impacts of disposal at sea and can reduce the need for natural gas flaring, decreasing greenhouse gas emissions. Economically, although it has operational costs, water injection increases the value of the field by maximizing reserve extraction, more than offsetting the initial investment.

The water injection systems face several operational problems, such as fouling, corrosion, biological contamination, and chemical incompatibility, which can cause blockages and damage to equipment. Fouling and biofouling, resulting from the interaction of waters with different chemical compositions, can block pores and pipelines, reducing injection efficiency. In addition, corrosion, caused by elements such as oxygen and sulfides, compromises the integrity of metallic materials, requiring constant maintenance and the use of resistant materials. Water compatibility is crucial to avoid the formation of precipitates and emulsions that obstruct the flow in the reservoir.

Another significant problem is the loss of injectivity, which occurs when the ability to inject water into the reservoir decreases due to blockages in the interface region between the injection well and the reservoir. The injection efficiency can be compromised by wells operating in open loop, i.e., without automatic flow rate and pressure control systems, which leads to suboptimal operations and loss of opportunities to maximize oil recovery.

One point that must be taken into account in the operation of injection wells is the geomechanical boundary pressure of the reservoir. The geomechanical boundary pressure of a reservoir is a fundamental concept in reservoir engineering and refers to the maximum pressure that the reservoir can withstand without mechanical failure occurring in its geological structure. This pressure is determined by the strength of the rocks that make up the reservoir and by the stresses acting on them, including the pressure of the fluids (oil, gas and water) and tectonic stresses.

Maintaining reservoir pressure within safe geomechanical boundaries is essential to preserve its structural integrity and optimize oil production. This involves continuous monitoring of fluid pressure and balancing water or gas injection rates with oil production, avoiding both over-pressurization and under-pressurization that can compromise the reservoir stability and integrity. The use of advanced technology, such as pressure sensors and real-time data analysis systems, can allow for the detection of pressure changes or approaches to the maximum allowable pressure limit. In addition, it is important to control flow rates to prevent unwanted fractures.

It is very common in the offshore oil production industry to operate water injection wells in an open loop, that is, without a control system monitoring and acting automatically. Operating wells without an adequate flow rate and pressure control system can lead to significant inefficiencies and potentially compromise the geomechanical integrity of the reservoir. The lack of control allows fluid pressure and flow rate to fluctuate significantly, increasing the risk of over-pressurization or under-pressurization of the reservoir. This not only decreases oil recovery efficiency but can also induce unwanted fractures, in addition to reducing the permeability and connectivity of the pores within the rock formation. As a result, the production becomes less predictable and more prone to sudden drops, with risks of frequent and costly interventions to correct problems that could have been avoided with adequate control. In addition, without control, there is a greater possibility of exceeding the geomechanical boundary pressure, which can cause irreparable structural damage to the reservoir, compromising the longevity and profitability of the oil field.

Document CN115099539A discloses a method and system for injecting water into oil wells using big data and artificial intelligence (AI), aiming to optimize the water injection process and improve oil recovery. This system operates using advanced mathematical models, deep neural networks, and machine learning models to predict oil production and water injection in each well. In addition, the residual neural network is one of the system components used to predict the water absorption capacity and adjust the injection process. The system also adopts a control approach that avoids pressure overload, preventing damage to the reservoir. The algorithm continuously measures interference factors between layers and adjusts the water injection, ensuring that each layer receives the ideal amount of water without overloading the geological structures, and also acts as a decision support tool, as it provides critical real-time information based on AI models, neural networks, and mathematical algorithms to support operational decisions, even preventing potential damage. Its ability to predict, monitor, and automatically adjust the water injection and oil production parameters ensures that operators have accurate data.

Document CN105676633A discloses a production well control method and system for acquiring real-time status information from the production well injection-production system and transmitting the same to a controller that performs closed-loop control on the injection-production system. The disclosed production well control method and system can meet the production well control requirements at the point of optimal working condition, achieve optimal system control, and improve system efficiency.

Document U.S. Pat. No. 11,821,289B2 discloses techniques that include real-time nodal analysis to automate production optimization for smart well completions. These techniques combine segment production data and bottomhole parameter estimates to provide optimal flow control valve (ICV) configurations to improve the performance of multisegment wells. Optimal configurations can be defined as the configurations that maximize the production of a multisegment well over a period of time. In some implementations, the automated model optimization can be used to perform real-time optimizations, bringing a production optimization approach using real-time data and a nodal model to multisegment wells. In some implementations, optimization algorithms can be used to help determine optimal production scenarios for complex wells, such as multisegment wells. For example, based on data from a well's current production conditions, an algorithm can recommend changes to bottomhole valve configurations that allow for optimized production.

Document US2023114088A1 discloses a production control system that can be used to optimize hydrocarbon production from a well using a nonlinear, data-driven Artificial Intelligence (AI) model. An analysis of the relation between the dynamics of flow variables (e.g., multiphase flow rates at the wellhead, well pressures, and temperatures) associated with the hydrocarbon production from a well and wellhead pressure values at various times can facilitate a more precise prediction of future multiphase flow rates from the well. Such analysis can be represented in the data-driven model that can be used by the production control system to generate ideal control configurations for a throttling valve for enhanced well production control. The data-driven model can be defined based on available production data and sensor data using system identification techniques such as a dynamic mode decomposition (DMD) algorithm. In addition, the data-driven model can be corrected using data assimilation methods.

In this way, despite technological developments, the state of the art does not disclose a solution by means of a method of controlling water injection wells in oil reservoirs by using algorithms, which would allow for improved efficiency and reduced risks to the integrity of the reservoir rock.

The disclosure described below stems from ongoing research in this segment, which aims at developing a solution capable of enabling the implementation of decisions based on models and algorithms to increase the efficiency of water injection in reservoirs.

The algorithm of the present disclosure is called WAVE, an acronym for Waterflow Autonomy and Verification Expert, and works based on mathematical models and feedback control logic.

The WAVE methodology can be applied to wells with injection/control valves (choke valves) with automatic actuation or to manual valves in which the field operator makes the changes to the valve opening.

When a remotely actuated choke valve is available, WAVE performs continuous operational diagnostics to verify whether the flow rate portion of water injection is being met and whether the pressure at the injection string bottom is within the geomechanical boundaries of the reservoir for the well in question. Based on this diagnosis, WAVE calculates and adjusts the choke valve action to maximize water injection without the pressure at the bottom of the well exceeding the geomechanical boundary. This continuous process allows the injection well to operate efficiently and safely, staying within production targets for longer and increasing the operational efficiency.

If the remote actuation of the choke valve is not available, i.e., if a manual actuation of this valve is required, WAVE enters decision-making support mode. By using artificial intelligence models, WAVE estimates the opening or surface pressure at the top of the well to which the well must be brought so that the desired flow rate portion is met, considering the geomechanical pressure boundary of the reservoir in this decision. Therefore, WAVE allows actuation on any type of choke valve to optimize the injection well.

### Objectives

The objective of the present disclosure is to provide a method for monitoring the geomechanical boundary of a reservoir and controlling water injection into the reservoir and maximizing production.

Another objective of the present disclosure is to provide a computer-readable storage medium capable of implementing model- and algorithm-based decisions to increase the efficiency of water injection into reservoirs.

Thus, the present disclosure describes a way to generate the necessary models and the design of automatic feedback control. Therefore, the expected benefits of using this technology range from improved well efficiency, allowing for increased production flow rate, to reduced risk to reservoir rock integrity.

### SUMMARY

The present disclosure relates to a method for maximizing water injection and ensuring the integrity of an oil reservoir, comprising the steps of:
receiving well information;
estimating the boundary value of the geomechanical pressure;
defining reference values for the water injection portion;
defining reference values for bottomhole pressure;
controlling the water injection flow rate;
monitoring the reservoir state; and
controlling the opening value of the control valve.

Additionally, the present disclosure also relates to a computer-readable storage medium which, upon receiving a set of instructions, will perform the steps of the method of the present disclosure.

### BRIEF DESCRIPTION OF THE FIGURES

The present disclosure will be better understood from the detailed description and figures described below that refer to the same.

FIG. 1 is a flowchart representation of the WAVE methodology operating in closed-loop mode using an overriding strategy.

FIG. 2 is a representation of the WAVE methodology operating in closed-loop mode based on an overriding strategy between injection portions and boundary pressure.

FIG. 3 is an example of a WAVE methodology screen for interfacing with operators.

FIG. 4 is an illustration of the performance of a decision-making support model of the WAVE methodology based on MLP (Multilayer Perceptron).

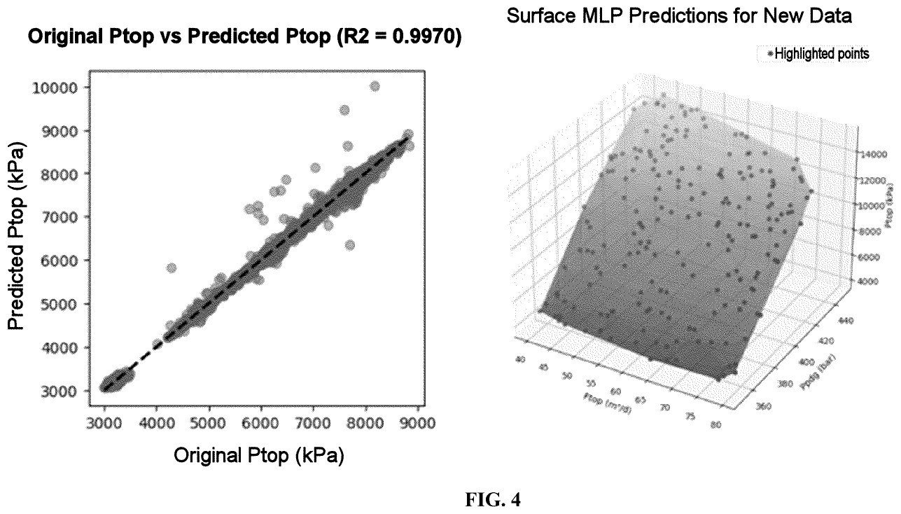

FIG. 5 is an illustration of the operational decision support model of the WAVE methodology.

FIG. 6 is an example of the use of the WAVE methodology.

FIG. 7 presents the sum of the time above the geomechanical boundary of 5 injection wells of the same unit before and after the implementation of WAVE.

FIG. 8 is a flowchart illustrating the steps for maximizing water injection and ensuring the integrity of the oil reservoir, according to the method of the present disclosure.

### DETAILED DESCRIPTION

The following description constitutes only a preferred embodiment within the scope of the present disclosure.

The present disclosure aims at controlling water injection/reinjection wells in oil reservoirs through an algorithm-based operating methodology called WAVE, an acronym for Waterflow Autonomy and Verification Expert.

The WAVE methodology can be applied in closed-loop or open-loop configuration, depending on the configuration desired by the user and the instrumentation available in the wells and the SPU water plant.

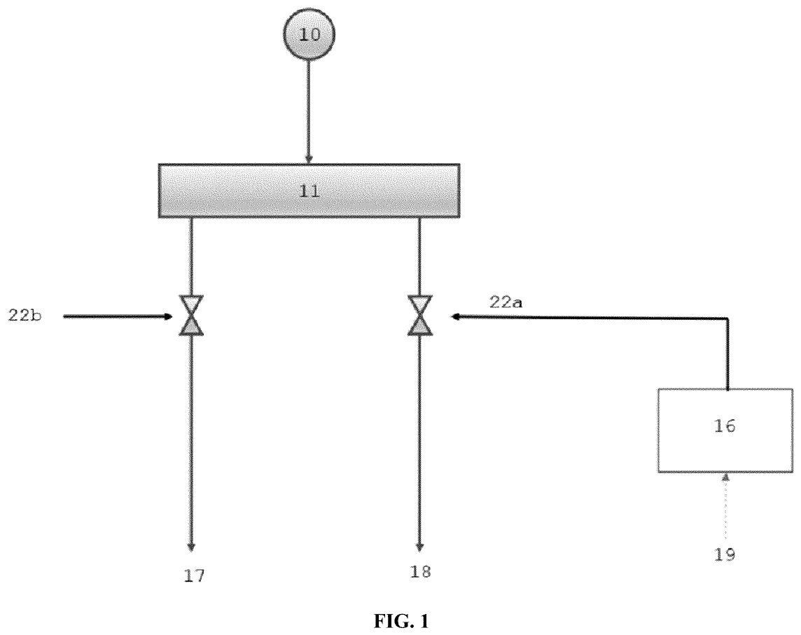

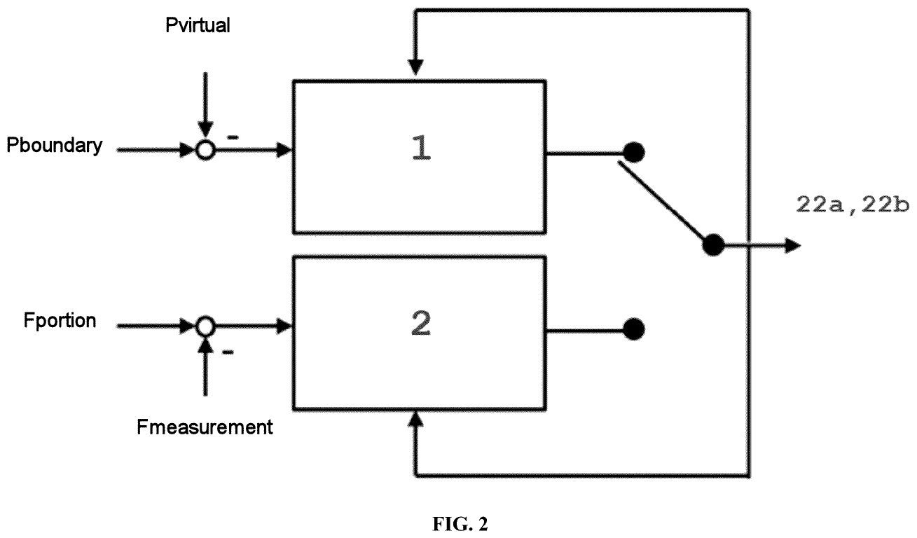

The closed-loop mode uses algorithms that allow the maximum possible amount of water to be injected, respecting the desired injection portion and the geomechanical boundary pressure of the reservoir. Thus, the well operates fully in automatic mode, wherein the actuations on the choke-type control valve for the injection well is coordinated by the algorithm's actions. FIGS. 1 and 2 schematically illustrate WAVE operating in closed loop.

In FIG. 1, element 10 represents the water injection pump, while element 11 corresponds to the water distribution head for the wells. Elements 22a and 22b are the choke valves for wells 18 and 17, respectively. In this configuration, the choke valve of well 18 is manipulated by the WAVE algorithm, represented by block 16. The WAVE signal inputs, indicated by arrow 19, include: bottomhole pressure, well flow rate, downstream pressure of the choke valve, as well as the set points for the desired injection portion and the maximum pressure allowed by the geomechanical boundary. FIG. 2 illustrates the closed-loop operating logic of WAVE, which uses an override strategy to switch control between two algorithms, which can be purely I (integral) and/or PI (proportional-integral), represented by blocks 1 and 2. This approach ensures that both variables remain within the desired operating ranges. The inputs of the controllers correspond to the calculated error between the variables measured in the field and the operational references provided to the algorithm by the operators. This configuration ensures that the pressure does not exceed the geomechanical boundary, even to reach the injection portion, and that the injection portion is not compromised to reach pressures close to the geomechanical boundary.

In the closed-loop operating mode, WAVE uses as input variables the information received S100 from wells 17, 18 as flow rate data and pressure data. It is necessary that at least real-time information be provided on the measurement of the flow rate of water injected into the well and of the bottomhole pressure where the geomechanical boundary pressure 19 is estimated S200.

This bottomhole pressure is called PWF. These WAVE input variables can be collected S101 directly from field sensors or can be estimated by inferences, which are models that seek to infer process variables through secondary measurements, i.e., that have some degree of correlation with the inferred variable. Typically, the input variables of a controller are called process variables (PV).

In this way, an injection/reinjection well operation team needs to define S300 reference values for the water injection portion and define S400 reference values for the PWF pressure. The water injection portion is the desired water flow rate, that is, a value normally defined by reservoir engineering teams to maximize the field production. In turn, the PWF pressure values should be an injection pressure, at the point where the reservoir integrity boundary pressure (geomechanical boundary) is calculated, and should be defined as a value close to this boundary, but slightly lower. This margin between the geomechanical boundary pressure and the desired PWF pressure should be defined in S301 by the engineering and operation teams (for example, a reasonable value would be 5 bar (0.5 MPa) less than the geomechanical boundary pressure). These desired values for the portion and pressure are called the set point (SP).

WAVE's closed-loop control strategy is based on an override algorithm. Override control is a technique used in industrial control systems to ensure that critical variables remain within safe limits, even if this means temporarily cancelling (or “overriding”) the normal control of a process. In a system with override control, there are usually multiple controllers 1, 2 acting on the same manipulated variable 22a, 22b (like a valve). Each controller 1, 2 has a specific objective, such as controlling pressure, temperature, or flow. The different controllers have different priorities. The controller with the highest priority can “override” the control of the others if the variable it is monitoring approaches a critical limit. The override control is fundamental in situations where process safety is paramount. In addition, the override control helps maintain process stability by preventing critical variables from going out of control. In summary, the overlap control is an approach that ensures that, in any situation in which the process conditions may become dangerous or unstable, the system will prioritize the most critical corrective action, even if this means temporarily deviating from normal control objectives. The WAVE methodology uses this overlap strategy to control the water injection flow rate at the desired portion (S500), overriding this objective when the PWF pressure reaches the SP value (a value close to, but lower than, the geomechanical boundary pressure of the reservoir), through reservoir state monitoring (S600). The opening value (S700) of choke valves 22a, 22b, controlled by the WAVE methodology, is always the lowest output of the two parallel controllers 1, 2 that handle the PWF pressure and well flow rate. FIG. 2 illustrates this strategy of the WAVE methodology.

Controllers 1 and 2 are, respectively, the PWF pressure control algorithm and the well water injection flow rate control algorithm. These controllers can be of the PID (Proportional-Integral-Derivative) type; however, a recommendation, but not a limitation, is the use of pure I controllers. A pure I controller (or pure integral controller) is a type of controller in control engineering that bases its action on the integral term of the error over time. It is part of the PID control strategies, but in the case of a pure I controller, the proportional and derivative terms are omitted. One of the main advantages of the pure I controller is its ability to eliminate permanent error, also known as steady-state error. As it accumulates the error over time, it adjusts the output until the error is completely zeroed. It is useful in systems in which the response may be slow, but where the complete error elimination is crucial. This is common in temperature control processes, level control, or in flow systems that require high precision. Tuning a pure I controller involves properly defining its single control parameter, which is the integral time (or integral constant). This parameter determines how quickly the controller reacts to the accumulated error over time. Conventional tuning methods can be used to define the integral time of the controllers.

An alternative that improves the performance of the WAVE methodology, but is optional and not limiting, is the use of the event-based pure I controller. An event-based controller is a type of controller that adjusts the system output not at regular time intervals, as in traditional time-based controllers, but in response to specific events that occur in the system. These events can be changes in the state of a process variable, specific conditions that are met, or the arrival of new data that indicate the need for a corrective action. Events can be configured in the WAVE methodology according to the needs of each industrial installation, such as a deadband error between the desired value (SP) for the injection flow rate and the measured flow rate (PV). This reduces the number of algorithm actuations as needed, which may eventually result in increased choke valve lifespan.

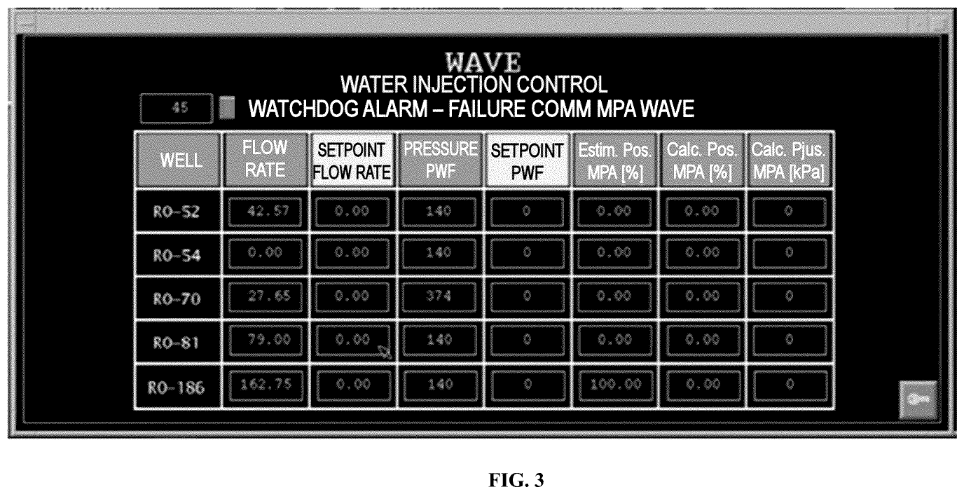

In open-loop operating mode, the WAVE methodology functions as an operational decision-making support algorithm. This means that the operator enters the desired SP values for portion and pressure on the WAVE methodology screen, as shown in FIG. 3, and the algorithm calculates the opening of choke valve 22a, 22b that should be applied in the field to achieve the desired flow rate-pressure conditions.

Alternatively, the WAVE methodology delivers the downstream pressure value of choke valve 22a, 22b that should occur in the field. This is valid for injection wells in which the choke valve 22a, 22b does not have a position reader, or in which this reader is not returning reliable values to the operation. In decision support mode, the actions indicated by the WAVE methodology must be applied in the field by an area operator.

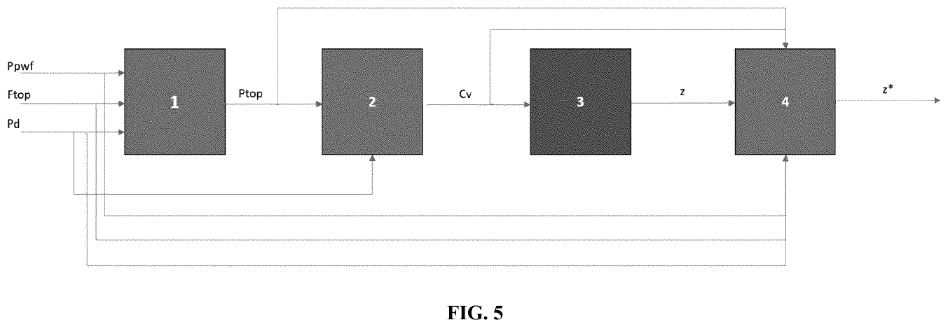

The models used in decision support mode are different from those used in closed-loop mode. In open loop, four models are used in series to generate the actuation recommendations for the choke valve 22a, 22b. The first model, block 1 of FIG. 5, aims to estimate the downstream pressure of the choke valve, by using as input variables the pump discharge pressure 10 (or header pressure 11, as illustrated in FIG. 1), the injection water flow rate (desired set point), and the PWF pressure (desired set point). This model can be designed based on neural networks, using historical well operation data for its training. The MLP (Multilayer Perceptron) based models are a good option and perform well in reconstructing the downstream pressure of the choke valve, as illustrated in FIG. 5. It is worth highlighting that this is one modeling option, but there are no limitations in choosing another type of neural network or even in using other techniques, such as algebraic models, for example.

The model 2, block 2 of FIG. 5, of the decision support mode is a single-phase flow model in a valve and uses the following variables as input: water flow rate F(z) and the difference between the inlet and outlet pressures of the choke valve ΔP. The model output is the flow rate capacity of the valve Cv(z), as per Equation 01.

$$C v ( z ) = \frac{F ( z )}{\sqrt{Δ P}}$$

wherein: Cv(z)=flow rate capacity
F(z)=water flow rate
ΔP=difference between the inlet and outlet pressures of the control valve.

The value of Cv(z) is then used by a third model, block 3 of FIG. 5, which is based on the characteristic curve of the choke valve provided by the equipment manufacturer. The valve manufacturer provides a table with Cv and choke opening values, which can be correlated in an algebraic equation to generate an estimate of the choke valve position for the desired conditions of PWF and injection portion.

The choke valve opening value must be corrected since the Cv (flow rate coefficient) and the opening provided by the manufacturer may deviate from the original values over time due to natural wear of the equipment. These wears can have several origins such as: corrosion; internal valve components, such as the body, seat, and choke, may suffer wear and corrosion over time, altering the internal geometry, potentially reducing the effective flow area and, consequently, the valve's actual Cv; accumulation of material deposits such as scale, sediment, or chemicals on the valve's internal surfaces, restricting flow and changing the opening behavior; maintenance and repairs may cause changes in the valve's characteristics, especially if replacement parts are not identical to the originals. To correct the valve value, or to adapt the opening estimate to the current installed characteristics, a fourth model is required, block 4 of FIG. 5, and the last model in the WAVE decision support mode. This model can be designed based on neural networks, using historical well and valve data for its training, provided that the equipment has a position gauge that indicates the valve opening. The models based on MLP (Multilayer Perceptron) are a good option and perform well in capturing valve wear. It is important to emphasize that the MLP network is a modeling option, but there are no limitations in choosing another type of neural network or even in using other techniques, such as algebraic models.

The WAVE operational decision support model is schematized in FIG. 5, where Ppwf is the PWF pressure set point, Ftop is the well water flow rate set point, Pd is the pump discharge pressure or the water header of the injection wells, Ptop is the downstream pressure of the choke valve, Cv is the estimated flow rate coefficient for the valve, z is the estimated valve opening, and z* is the estimated valve opening considering equipment wear.

The two operational modes of WAVE, closed loop and open loop (decision support), allow the methodology to be applied at different instrumentation levels of the actuation valves in the field, as well as allowing flexibility for operational teams to choose the most appropriate way to use the algorithms. Thus, WAVE allows the optimization of the operation of injection wells, in addition to protecting the integrity of the reservoir rock through the aid of automatic control algorithms, models and artificial intelligence.

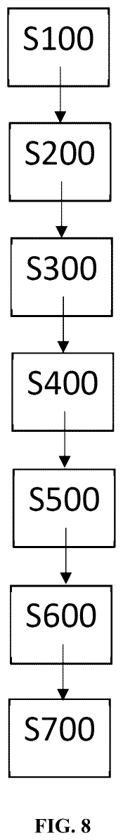

In this way, the WAVE methodology performs the steps illustrated in FIG. 8 to achieve the maximization of water injection and ensure the integrity of the oil reservoir.

### Example

The examples in this section are intended to illustrate one of the numerous embodiments of the disclosure, however without limiting its scope of protection.

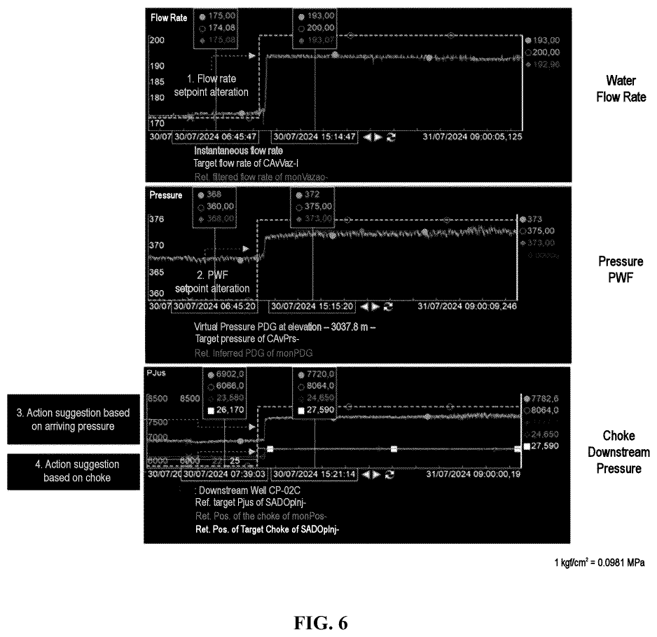

In this example, as illustrated in FIG. 6, the operational decision-making assistance mode with the support of the WAVE methodology will be presented in a real injection well of a SPU operating in ultra-deep waters.

The demonstration test was initiated at 10:00 when the team decided to activate the WAVE methodology to evaluate the quality of decision-making in water injection operations in wells. The injection well X was selected by the reservoir and lift engineers.

Before the test, well X was operating with a bottomhole pressure (PWF) of 368 kgf/cm² (36.09 MPa) and an injection flow rate of 175 m³/h. The downstream pressure of the choke valve at the surface was 6930 kPa. With the scenario ready, the engineering team established new set points together with the operation: the bottomhole pressure (PWF) should be raised to 375 kgf/cm² (36.78 MPa) and the injection flow rate adjusted to 200 m³/h.

Around 10:30, the operation reported that the set points had been changed according to the guidelines. WAVE then estimated that, with these new configurations, the downstream pressure of the choke valve should be increased to 8070 kPa. The teams reviewed the estimates provided by WAVE and, after validating the results, the operation was instructed to proceed with the change in the injection plant.

The area operator was then called upon to manually adjust the well choke valve. At 11:02, he performed the task, and the results began to unfold. The downstream pressure of the choke valve in the field was manipulated by the operator to 7691 kPa, resulting in an increase in the bottomhole pressure to 372 kgf/cm² (36.48 MPa). The injected water flow rate, in turn, increased to 193 m³/h, representing an increase of 18 m³/h, or 432 m³/day, in the water injection from well X.

According to the reservoir engineering teams, this increase in water injection results in an increase in production of approximately 540 barrels of oil per day.

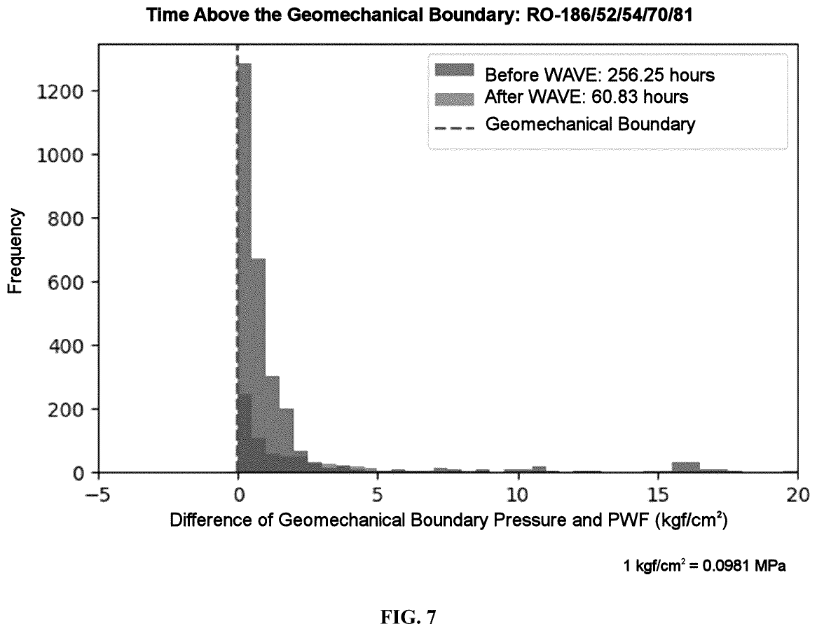

FIG. 7 illustrates a histogram showing the operating time above the geomechanical boundary of five injection wells belonging to the same production unit. The data were organized into two distinct periods: three months before and three months after the implementation of WAVE. A significant reduction in the time of exposure to high pressures is observed, from 256.25 hours to only 60.83 hours, which corresponds to a decrease of more than 75% in the infringement of the maximum recommended pressure boundary. This result highlights the effectiveness of WAVE, demonstrating that the methodology not only improves the efficiency of the injection process, but also reinforces the guarantee of the reservoir integrity.

1. A method for maximizing water injection and ensuring the integrity of an oil reservoir, comprising:
receiving information related to a well;
estimating a boundary value of a geomechanical pressure;
defining reference values for a water injection portion;
defining reference values for a bottomhole pressure;
controlling a water injection flow rate;
monitoring a reservoir state; and
controlling an opening value of the control valve.

2. The method of claim 1, wherein the step of estimating the boundary value of the geomechanical pressure comprises collecting information on water flow rate injected into the well and the bottomhole pressure.

3. The method of claim 1, wherein the step of defining the reference values for the bottomhole pressure comprises defining a value at least 5 bar (0.5 MPa) less than the boundary value of the geomechanical pressure.

4. The method of claim 1, wherein the step of controlling the water injection flow rate is performed by an override algorithm.

5. The method of claim 1, wherein the step of monitoring the reservoir state is performed by first and second controllers.

6. The method of claim 5, wherein the first controller is a bottomhole pressure control algorithm and the second controller is a well flow rate control algorithm.

7. The method of claim 5, wherein the first and second controllers are PID type controllers.

8. The method of claim 5, wherein the first and second controllers are pure integral controllers.

9. The method of claim 8, wherein the first and second controllers are event-based controllers.

10. The method of claim 1, wherein the step of controlling the opening value of the control valve is performed autonomously by means of an algorithm from the reservoir state data.

11. The method of claim 1, wherein the step of controlling the opening value of the control valve is performed by means of a decision support model.

12. The method of claim 11, wherein a series model estimates the downstream pressure of the control valve, the flow rate of the injection water, and the bottomhole pressure.

13. The method of claim 11, wherein the series model is a single-phase flow model in a valve, according to the equation:
$$C v ( z ) = \frac{F ( z )}{\sqrt{Δ P}}$$
wherein: Cv(z)=flow rate capacity,
F(z)=water flow rate, and
ΔP=difference between the inlet and outlet pressures of the control valve.

14. The method of claim 11, wherein the series model is a model based on at least one of neural networks or historical data from the well and the control valve.

15. A computer-readable storage medium, characterized in that it comprises a set of instructions, wherein, when the set of instructions is executed on a computer, it causes the computer to perform the method as defined in claim 1.
